(19) United States
(12) Patent Application Publication
(10) Pub. No.: US 2014/0053005 A1
(43) Pub. Date: Feb. 20, 2014

(54) STORAGE DEVICE AND DATA STORAGE SYSTEM

(71) Applicant: HON HAI PRECISION INDUSTRY CO., LTD., New Taipei (TW)

(72) Inventor: CHUN-SHENG CHEN, New Taipei (TW)

(73) Assignee: HON HAI PRECISION INDUSTRY CO., LTD., New Taipei (TW)

(21) Appl. No.: 13/949,267

(22) Filed: Jul. 24, 2013

(30) Foreign Application Priority Data
Aug. 14, 2012 (CN) 2012102878524

(51) Int. Cl. G06F 1/26

(52) U.S. Cl. CPC G06F 1/266
USPC 713/300

(57) ABSTRACT

A mobile storage device is powered without using an external power supply when the mobile storage device is connected to a computing device. The mobile storage device includes a voltage regulator to receive a first voltage from a data transmission interface (e.g., USB interface) of the computing device. The voltage regulator converts the first voltage into several other voltages suitable for all other electronic components of the storage device, to provide full power to the mobile storage device.

### BACKGROUND

1. Technical Field

Embodiments of the present disclosure relate to storage devices, and particularly to a storage device and a storage system having the storage device.

2. Description of Related Art

A mobile storage device, such as a mobile hard disk (HD), is powered using an external power device. For example, a mobile hard disk having a universal serial bus (USB) interface may need a power adapter to provide a direct-current voltage of 12V, and then a voltage regulator of the mobile hard disk regulates the 12V voltage to a voltage of 5V or 3.3V (for example) to supply power for other components of the mobile hard disk. However, use of the external power device is inconvenient and may be costly. Therefore, there is room for improvement in the art.

### BRIEF DESCRIPTION OF THE DRAWINGS

FIG. 1 illustrates a schematic block diagram of one embodiment of a storage device.

FIG. 2 illustrates a schematic diagram of one embodiment of a data storage system including the storage device of FIG. 1.

FIG. 3 illustrates a schematic diagram of another embodiment of the data storage system having the storage device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

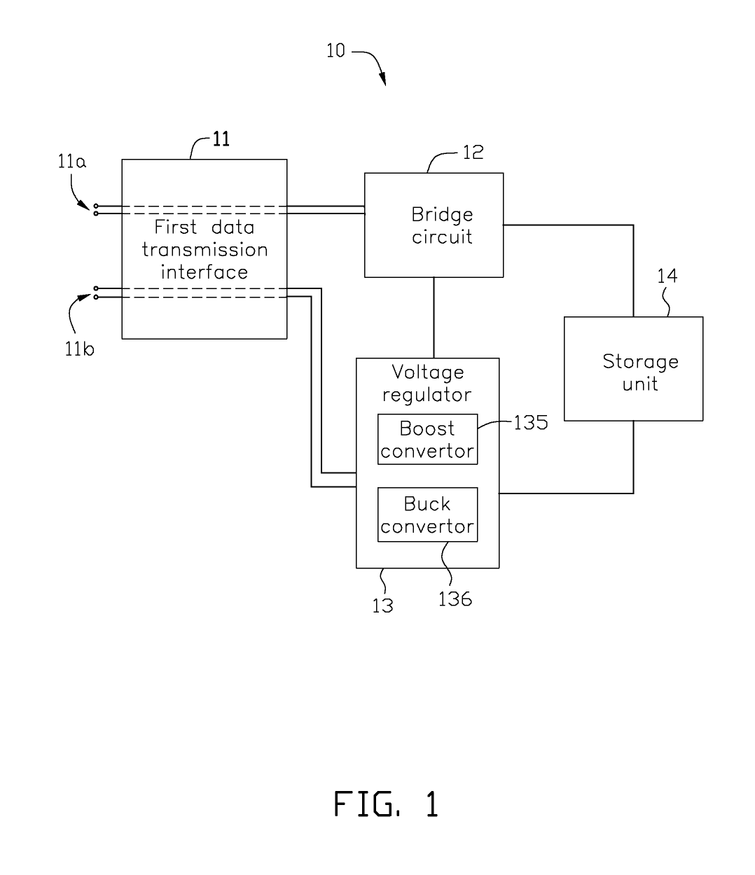

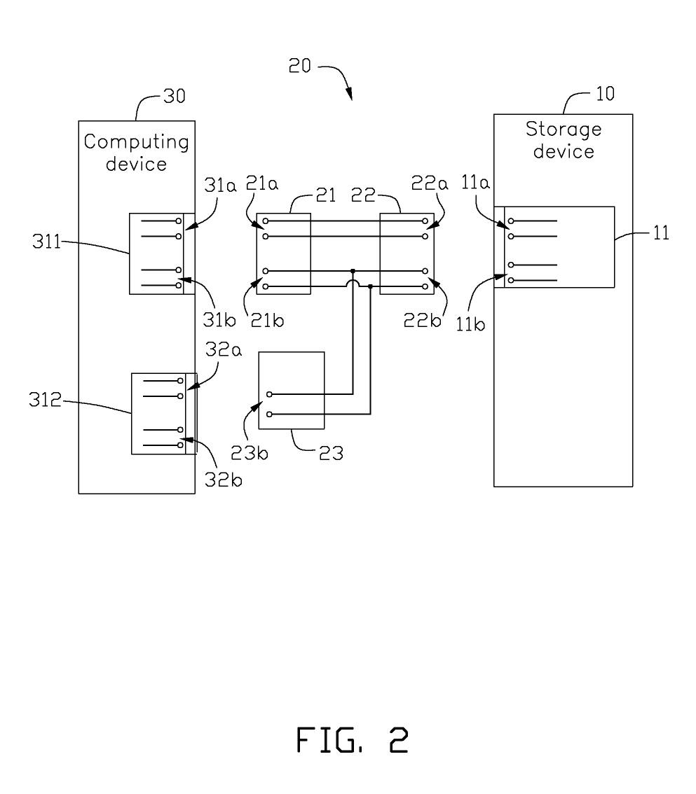

Referring to FIG. 1, a storage device 10 including a plurality of electronic components such as a first data transmission interface 11, a bridge circuit 12, a voltage regulator 13, and a storage unit 14, is shown. In the embodiment, the storage device 10 may be, for example, a mobile hard disk (HD). The storage device 10 is capable of communicating with another external device via a wired connection, such as via a universal serial bus (USB) connection, to exchange data with the external device. The external device may be a computing device 30 (shown in FIG. 2).

The first data transmission interface 11 is configured to connect to a data transmission interface of the external device (e.g., a second data transmission interface 311 of the computing device 30 of FIG. 2), to establish a data exchange path between the storage device 10 and the external device. The storage unit 14 is configured to store data transmitted from the external device. The stored data can be transmitted to the external device through the first data transmission interface 11.

The bridge circuit 12 converts between data transmission protocols of the storage device and the external device, to realize data transmission between the storage device and the external device when the storage device and the external device support different data transmission protocols. In the embodiment, the bridge circuit 12 can be for example a USB to SATA bridge.

The first data transmission interface 11 includes a first data port 11a and a first power port 11b. The first data port 11a may include multiple data transmission pins. In the embodiment, the first data transmission interface 11 is a USB interface to connect to a USB interface of the external device. Accordingly, the first data port 11a may include two or six data transmission pins corresponding to different versions (e.g., USB 2.0 or USB 3.0) of the USB interface. The first power port 11b receives a first voltage and a first current from the USB interface of the external device.

The voltage regulator 13 embedded in the storage device 10 is electrically connected to the power port 11b, to regulate a first voltage transmitted to the power port 11b by the external device. In one example, the first voltage is transmitted to the power port 11b from the USB interface of the external device. In the embodiment, a value of the first voltage is 5V, and a value of the first current is 2 A.

The voltage regulator 13 converts the first voltage into a second voltage which is higher than the first voltage and a third voltage which is lower than the first voltage, and then selectively outputs one or more of the first, second and third voltages to other electronic components of the storage device 10. For example, the voltage regulator 13 may output the first voltage to the storage unit 14, and output the third voltage to the bridge circuit 12, to power the storage unit 14 and the bridge circuit 12 using the first and third voltages respectively. In the embodiment, the voltage regulator 13 includes a boost converter 135 and a buck converter 136. The boost converter 135 converts the first voltage into the second voltage. The buck converter 136 also converts the first voltage into the third voltage. A value of the second voltage is 12V, and a value of the third voltage is 3.3V.

Referring to FIG. 2, a data storage system which includes the storage device 10, a data transmission element 20, and the computing device 30 is shown. The storage device 10 is connected to the computing device 30 via the data transmission element 20, to establish a data exchange path between the storage device 10 and the computing device 30. The computing device 30 includes a second data transmission interface 311 and a third data transmission interface 312. In the embodiment, both of the second and third data transmission interfaces 311, 312 are USB interfaces.

The data transmission element 20 includes a first interface 21, a second interface 22, and a third interface 23. The second interface 22 is connected to the third interface 23 via wires. The first interface 21 is configured to connect to the computing device 30. The second interface 22 is configured to connect to the storage device 10.

The first interface 21 is electrically connected to the second data transmission interface 311 of the computing device 30. The first interface 21 includes a second data transmission port 21a and a second power port 21b. The second interface 22 includes a third data transmission port 22a and a third power port 22b. The second data transmission port 21a is connected to the third data transmission port 22a. The second power port 21b is connected to the third power port 22b. The second and third data transmission ports 21a, 22a are configured to transmit data between the storage device 10 and the computing device 30. The second power port 21b receives the first voltage and the first current from the computing device 30 and transmits the first voltage and the first current to the storage device 10 via the third power port 22b.

The third interface 23 is electrically connected to the second data transmission interface 312 of the computing device 30, to receive a second voltage and a second current from the second data transmission interface 312, and apply the second current to the second power port 21b. In the embodiment, the third interface 23 includes a fourth power port 23b to receive the second current. A value of the second current is 2 A, the same as the first current. Thus, a greater amount of power is supplied to the storage device 10 to drive the storage device 10.

The second data transmission interface 311 includes a fourth data transmission port 31a electrically connected to the second data transmission 21a and a fifth power port 31b electrically connected to the second power port 21b to output the first voltage and the first current.

The third data transmission interface 312 includes a fifth data transmission port 32a and a sixth power port 32b electrically connected to the fourth power port 23b of the third interface 23, to output the second voltage and the second current to the fourth power port 23b.

In the embodiment, the second data transmission interface 311 and the third data transmission interface 312 are substantially the same as each other. In other embodiments, the first interface 21 can be connected to the third data transmission interface 312, and the third interface 23 can be connected to the second data transmission interface 311. The data transmission element 20 may be a data transmission line having first, second, and third interfaces.

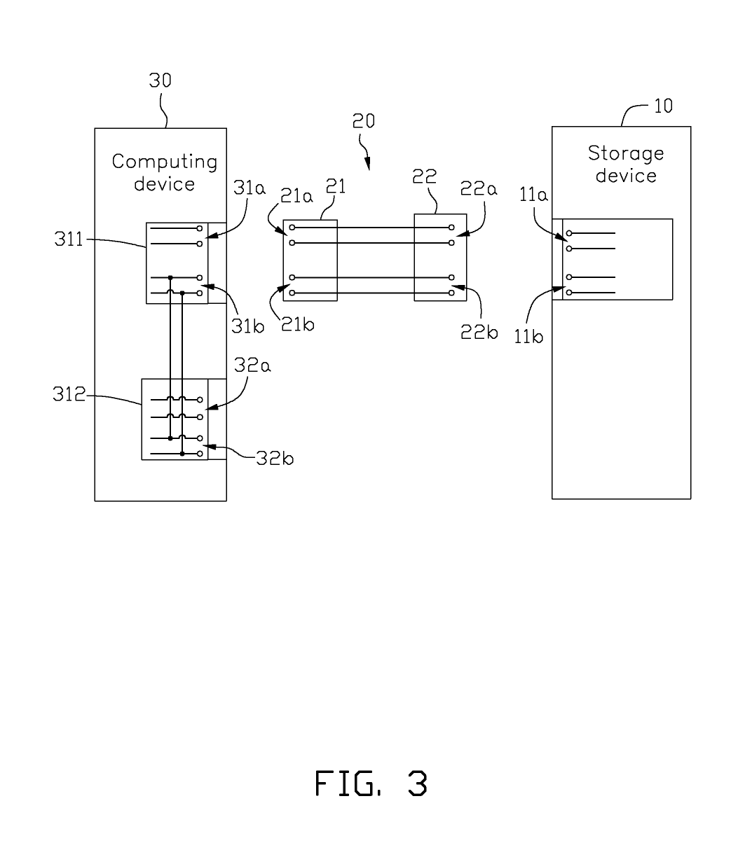

Referring to FIG. 3, the data storage system according to another embodiment is shown. In this embodiment, the third interface 23 is omitted. The fifth power port 31b of second data transmission interface 311 is connected in parallel to the sixth power port 32b of the third data transmission interface 312. Thus, both the first current and the second current can be output to the storage device 10, which makes the first and second currents available to power the storage device 10.

As described above, the storage device 10 can be directly powered by the voltages and currents output from the computing device 30 when the storage device 10 exchanges data with the computing device 30. Thus, an extra external power supply device can be omitted. It is far less inconvenient for a user to use the storage device 10.

Although certain embodiments of the present disclosure have been specifically described, the present disclosure is not to be construed as being limited thereto. Various changes or modifications may be made to the present disclosure without departing from the scope and spirit of the present disclosure.

1. A storage device, comprising:
a first data transmission interface configured to connect to a second data transmission interface of a computing device, to establish a data exchange path between the storage device and the computing device; and
a voltage regulator configured to receive a first voltage from the second data transmission interface of the computing device, convert the first voltage into a second voltage and a third voltage, and selectively output one or more of the first, second, and third voltages to other electronic components of the storage device.

2. The storage device according to claim 1, wherein the second voltage is higher than the first voltage and the third voltage is lower than the first voltage.

3. The storage device according to claim 1, wherein the storage device is a mobile hard disk.

4. The storage device according to claim 1, wherein the regulator comprises a boost converter that converts the first voltage into the second voltage and a buck converter that converts the first voltage into the third voltage.

5. The storage device according to claim 1, further comprising a bridge circuit and a storage unit, the bridge circuit is electrically connected between the first data transmission interface and the storage unit, the bridge circuit is configured to converts between data transmission protocols of the storage device and the computing device, to realize the data transmission between the storage device and the computing device when the storage device and the computing device support different data transmission protocols.

6. The storage device according to claim 1, wherein the first data transmission interface and the second data transmission interface are universal serial bus (USB) interfaces.

7. The storage device according to claim 1, wherein each of the first data transmission interface and the second data transmission interface comprises a data transmission port and a power port, the data transmission port of the first data transmission interface is configured to connect to the data transmission port of the second data transmission interface, and the power port of the first data transmission interface is configured to connect to the power port of the second data transmission interface to receive the first voltage output from the computing device.

8. The storage device according to claim 1, wherein a value of the first voltage is 5V, a value of the second voltage is 12V, and a value of the third voltage is 3.3V.

9. A data storage system, comprising:
a storage device comprising a first data transmission interface and a voltage regulator; and
a computing device comprising a second data transmission interface being electrically connected to the first data transmission interface and outputting a first voltage and a first current to the first data transmission interface;
wherein the voltage regulator is configured to convert the first voltage into a second voltage and a third voltage, and selectively output one or more of the first, second, and third voltages to other electronic components of the storage device.

10. The data storage system according to claim 9, wherein the second voltage is higher than the first voltage and the third voltage is lower than the first voltage.

11. The data storage system according to claim 9, wherein the first data transmission interface is electrically connected to the second data transmission interface via a data transmission line having a first interface and a second interface electrically connected to the first interface; the first interface is configured to connect to the second data transmission interface of the computing device, and the second interface is configured to connect to the first data transmission interface of the storage device.

12. The data storage system according to claim 11, wherein the computing device further comprises a third data transmission interface, the data transmission line further comprises a third interface connected between the third data transmission interface and the second interface, the third data transmission interface outputs a second current to the third interface, and the third interface transmits the second current to the first data transmission interface through the second interface to drive the storage device.

13. The data storage system according to claim 11, wherein the computing device further comprises a third data transmission interface, each of the second and third data transmission interfaces comprises a power port, the power port of the second data transmission interface is electrically connected in parallel to the power port of the third data transmission interface, and the power port of the second data transmission interface outputs a second current to the storage device through the data transmission line.

14. The data storage system according to claim 9, wherein the storage device is a mobile hard disk.

15. The data storage system according to claim 9, wherein the regulator comprises a boost converter that converts the first voltage into the second voltage and a buck converter that converts the first voltage into the third voltage.

16. The data storage system according to claim 9, wherein the storage device further comprises a bridge circuit and a storage unit, the bridge circuit is electrically connected between the first data transmission interface and the storage unit, the bridge circuit is configured to converts between data transmission protocols of the storage device and the computing device, to realize the data transmission between the storage device and the computing device when the storage device and the computing device support different data transmission protocols.

17. (canceled)

18. The data storage system according to claim 9, wherein a value of the first voltage is 5V, a value of the second voltage is 12V, and a value of the third voltage is 3.3V.

19. The data storage system according to claim 15, wherein each of the first, second, and third data transmission interfaces is a universal serial bus (USB) interface.

20. The data storage system according to claim 16, wherein each of the first, second, and third data transmission interfaces is a universal serial bus (USB) interface.
